(19) United States
(12) Patent Application Publication
(10) Pub. No.: US 2005/0086072 A1
(43) Pub. Date: Apr. 21, 2005

(54) Task-based system and method for managing patient care through automated recognition

(76) Inventors: Charles S. Fox JR., Leawood, KS (US); Greg Meyer, Smithville, MO (US)

Correspondence Address: SHOOK, HARDY & BACON L.L.P., 2555 GRAND BOULEVARD, KANSAS CITY, MO, 64108-2613, US

(21) Appl. No.: 10/684,834

(22) Filed: Oct. 15, 2003

(51) Int. Cl. G06F 17/60

(52) U.S. Cl. 705/2

(57) ABSTRACT

The present invention is directed to a method and system for managing patient care in order to minimize caregiver error. The system may be driven by machine readable identifiers. The identifiers may include bar codes. The system is also task-based so as to minimize caregiver input and the possibility of caregiver error. The system includes a caregiver portable information device having a scanning device. The system additionally includes a patient machine readable identifier and a medication machine readable identifier. The system further includes a dynamically generated patient task list for an identified patient, the task list including instructions for administration of at least one medication, wherein the task list becomes available upon scanning of the patient machine readable identifier by the scanning device.

### CROSS-REFERENCE TO RELATED APPLICATIONS

None.

### STATEMENT REGARDING FEDERALLY SPONSORED RESEARCH OR DEVELOPMENT

None.

### TECHNICAL FIELD

Embodiments of the present invention relate to management of patient care. More particularly, embodiments of the invention are directed to management of patient care directed at minimizing opportunity for caregiver error in an institutional environment.

### BACKGROUND OF THE INVENTION

With the shortage of skilled caregivers and the growing complexity of the healthcare industry, the potential for devastating healthcare errors has increased. Particular risks exist in dispensing of medications in an institutional environment. Mistakes are often made during this process due to the sheer number of constantly changing caregivers, the growing complexity of health care, and opportunities for error. In a hospital environment, post-surgical procedures can be the most dangerous segment of a patient's hospital stay. A large percentage of medication errors occurs in administration of medication due to mistaken patient identification, incorrect medication, or incorrect dosage. Misreading of decimal values for a prescribed dosage is far too common of a phenomenon.

Risks are further increased by errors in specimen testing and collection. Increased nursing workloads can lead to cumulative delays in labeling of specimens. The delays frequently result in inaccurate documentation.

Generally, caregivers are required to read, process and enter patient information in order to administer medications and other treatments. Caregivers such as nurses look at a set of instructions. The caregivers proceed to gather information by interpreting orders entered in a computer. The caregivers perform ordered procedures and create records of the procedures. Furthermore, the caregivers generally interpret an order for each patient. Each order contains a set of tasks. While the caregiver may only be performing one task from the order, the caregiver still is required to interpret the entire order. For example, an order may require administration of medication three times a day for three weeks. A task is performed each time medication is administered. To determine if a task should be performed, the caregiver must check the frequency and duration of the order to determine if action is required: These procedures involve an excessive number of steps and increase the potential for error.

Systems have been developed for managing medication administration, but suffer from various deficiencies. U.S. Patent Publication US 2002/0038392 to De La Huerga discloses a method and apparatus for controlling IV delivery and monitoring. The apparatus includes a patient device for storing patient information and a caregiver device for storing caregiver information. The caregiver uses the caregiver device to read the patient identifier to determine if a delivered medication is appropriate. This system does not allow for real time updating of patient information for multiple patients simultaneously. The system further does not provide real-time order changes to caregivers. Furthermore, the system is not centrally managed and is not a task-based system since it requires caregivers to interpret orders.

A solution is needed for managing healthcare that is both safe and efficient. The processes and components of the solution should drive care activities that are safe, consistent with a plan of care, properly documented and recorded, and protected from failure of primary systems at all times. The solution should further decrease the efforts and steps required of caregivers in order to minimize the opportunity for error.

### BRIEF SUMMARY OF THE INVENTION

In one aspect, the present invention is directed to a system for managing patient care. The system includes a portable information device having an identifier recognition device and a patient machine readable identifier. The system additionally includes a patient task list for an identified patient, wherein the task list becomes automatically available upon recognition of the machine readable identifier by the identifier recognition device.

In an additional aspect, the present invention is directed to a method for managing patient care. The method includes recognizing a patient machine-readable identifier, matching the patient machine-readable identifier with a patient task list, and providing the task list to a caregiver.

In yet an additional aspect, the invention is directed to a task-based system for managing patient care. The system includes a central information system having a database including patient data and a patient identifier for identifying a patient. The system additionally includes a portable information device having tools for reading the patient identifier and accessing the central information system to obtain the patient data, wherein the central information system includes an application for generating a task list upon obtaining the patient data.

In a further aspect, the invention is directed to a method for facilitating task performance by a caregiver. The method includes verifying a caregiver identifier and a patient identifier using a portable information device. The method additionally includes generating a task list for the identified caregiver and the identified patient and displaying the task list on the portable information device and individually recording performance of each task.

### BRIEF DESCRIPTION OF THE DRAWINGS

The present invention is described in detail below with reference to the attached drawings figures, wherein:

FIG. 1 is a block diagram illustrating components of a system for managing patient care in accordance with an embodiment of the invention;

FIG. 2 is a block diagram illustrating components of a system for managing patient care in accordance with an alternative embodiment of the invention;

FIG. 3 is a block diagram illustrating components of a central information system in accordance with an embodiment of the invention;

FIG. 4 is a block diagram illustrating a central database of the central information system in accordance with an embodiment of the invention;

FIG. 5 is a block diagram illustrating a caregiver portable computing device in accordance with an embodiment of the invention;

FIG. 6 is a diagram illustrating an identification device in accordance with an embodiment of the invention;

FIG. 7 is a block diagram illustrating a device link micro-server in accordance with an embodiment of the invention;

FIG. 8 is a flow chart illustrating a method for using the system in accordance with an embodiment of the invention;

FIGS. 9-16 illustrate screen displays of the caregiver portable information device in accordance with an embodiment of the invention;

FIG. 17 is a flow chart illustrating a method for setting up a patient room in accordance with an embodiment of the invention;

FIGS. 18A and 18B provide a flow chart illustrating a method for administering a medication in a single patient, multiple device environment in accordance with an embodiment of the invention; and

FIG. 19 is a flow chart illustrating various techniques for using the system in a multi-patient single device environment in accordance with an embodiment of the invention.

### DETAILED DESCRIPTION OF THE INVENTION

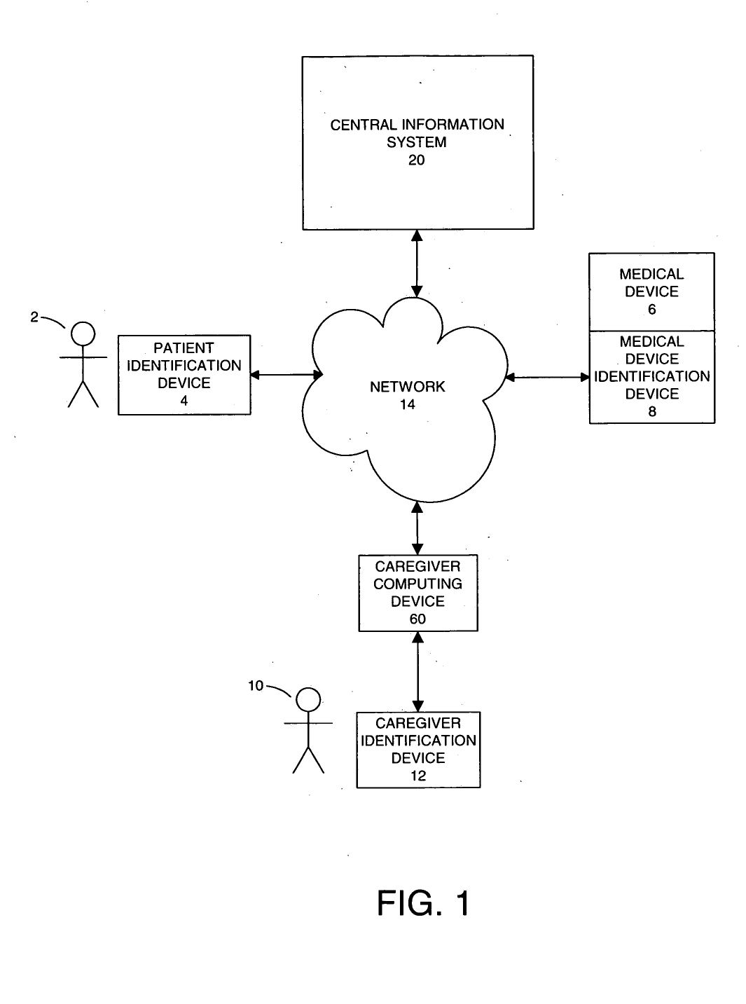

Embodiments of the present invention are directed to a system and method for managing patient care in a safe manner so as to minimize caregiver error and maximize efficiency. Having briefly provided an overview of the present invention, embodiments of the invention will be discussed with reference to FIGS. 1-19.

Specifically, with initial reference to FIG. 1, a patient identification device 4 may identify a patient 2 and a medical device or medication device identification device 6 may identify a medical device or medication 8. A caregiver identification device 12 may identify a caregiver 10. A central information system 20 and a caregiver portable computing device 60 are capable of communicating over a network 14. The caregiver portable computing device 60 is also capable of processing information from the patient identification device 4, the medical device identification device 8, and the caregiver identification device 12. The caregiver portable computing device 60 can transmit the information to the central information system 20. In this manner, each caregiver 10, each patient 2, and each medication or medical device 6 can be verified with the central information system 20. Although all components are shown as communicating over the network 14, peer-to-peer communication may also be possible. Each of the components of the system is described in greater detail below.

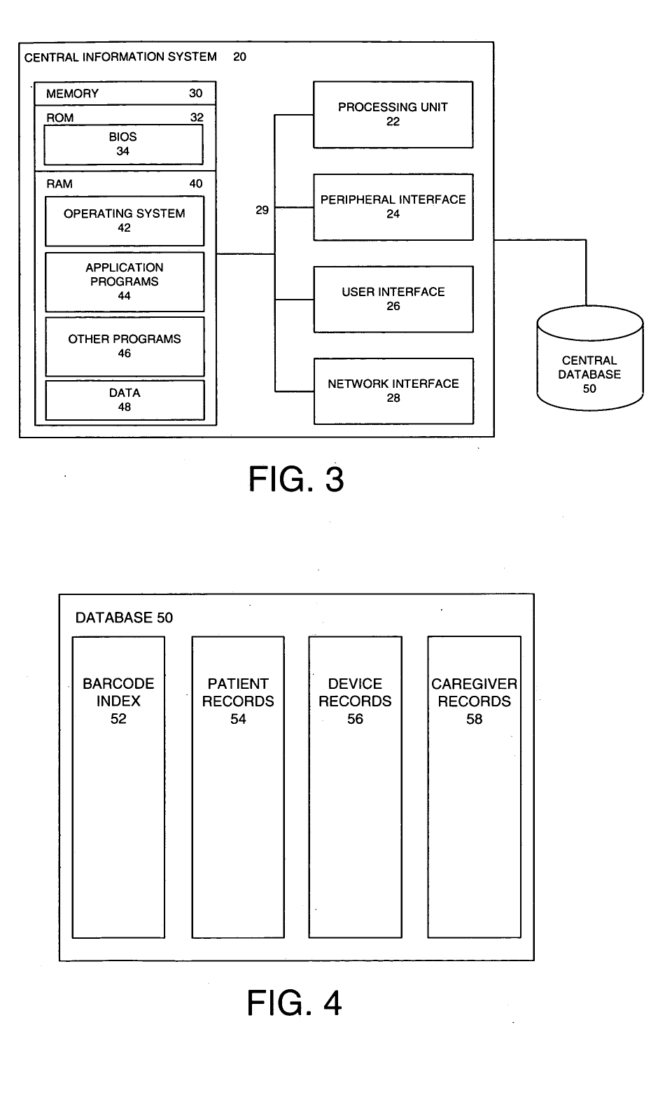

FIG. 3 illustrates an embodiment of the central information system 20. The central information system 20 may include a processing unit 22, a peripheral interface 24, a user interface 20, and a network interface 28. The central information system 20 may also include a memory 30. A system bus 29 couples the aforementioned components. The central information system 20 may also include a central database 50.

The system memory 30 may include computer storage media in the form of volatile and/or nonvolatile memory such as read only memory (ROM) 32 and random access memory (RAM) 40. A basic input/output system 34 (BIOS), containing the basic routines that help to transfer information between elements within the central information system 20, such as during start-up, is typically stored in ROM 32. RAM 40 typically contains data and/or program modules that are immediately accessible to and/or presently being operated on by processing unit 22.

By way of example, and not limitation, FIG. 3 illustrates operating system 42, application programs 44, other program modules 46, and program data 48. The application programs 44 and other programs 46 may be described in the general context of computer-executable instructions, such as program modules, being executed by a computer. The applications programs 44 include components for matching patient data, caregiver data, and medication data in the central database 50 with identifiers transmitted by the caregiver portable computing device 60. Furthermore, the application programs 44 include components for generating a patient task list. The task lists are based upon knowledge databases in the central information system 20 that dictate a particular course of care. These tasks lists may be contained within the patient records 54 and the caregiver records 58 that are described below with reference to FIG. 4. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like.

The central information system 20 may also include other removable/non-removable, volatile/nonvolatile computer storage media. A hard disk drive may be provided that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive is typically connected to the system bus through a non-removable memory interface and magnetic disk drive and optical disk drive are typically connected to the system bus by a removable memory interface.

A user may enter commands and information into the central information system through the user interface 26 using input devices such as a keyboard and pointing device, commonly referred to as a mouse, trackball or touch pad. Other input devices may include a microphone, satellite dish, scanner, or the like. These and other input devices are often connected to the processing unit 22 through a user input interface 26 that is coupled to the system bus 29, but may be connected by other interface and bus structures, such as a parallel port or a universal serial bus (USB). A monitor or other type of display device may also be connected to the system bus 29 via an interface, such as the peripheral interface 24. In addition to the monitor, computers may also include other peripheral output devices such as speakers and printer.

The illustrated central information system 20 is merely an example of a suitable environment for the system of the invention and is not intended to suggest any limitation as to the scope of use or functionality of the invention. Neither should the central information system 20 be interpreted as having any dependency or requirement relating to any one or combination of components illustrated.

The central information system 20 in the present invention will operate in a networked environment in conjunction with the network 14 as illustrated in FIG. 1, using logical connections to one or more remote computers, such as the caregiver portable computing device 60. As further described below, the caregiver portable computing device 60 may be a personal computer, and typically includes many of the elements described above relative to the central information system 20.

The network 14 may be the Internet and all components of the system may be accessible over the Internet. Logical connections for networking may include a local area network (LAN) or a wide area network (WAN), but may also include other networks. When used in a LAN networking environment, the central information system 20 may be connected to the LAN through the network interface 28 or adapter. When used in a WAN networking environment, the central information system 20 typically includes a modem or other means for establishing communications, such as the Internet. The modem, which may be internal or external, may be connected to the system bus 29 via the user input interface 26, or other appropriate mechanism.

FIG. 4 illustrates an embodiment of the central database 50 that is a component connected with the central information system 20. The central database 50 may include an identifier index 52 linking the identifiers to all of the identified patients, devices, medications, and caregivers. In the illustrated embodiment, the identifiers are barcodes and the identifier index 52 is a barcode index. However, the identifiers may include an RF identifier (RFID) or any machine readable identifier. Additionally, the central database 50 may include patient records 54, device records 56, and caregiver records 58. The patient records 54 preferably include each patient's treatment history and orders entered by a physician for treatment of each patient. The device records 56 preferably include device settings and capabilities. The caregiver records 58 preferably include records of assigned tasks for each caregiver in the system. The orders and other information can be accessed through the caregiver portable computing device 60 to determine appropriate tasks to be performed on an identified patient.

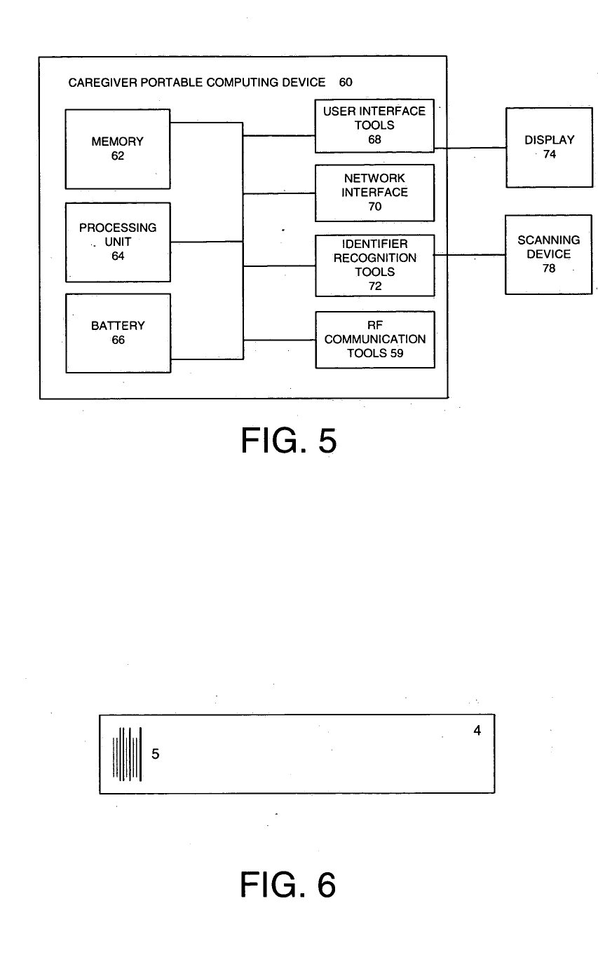

FIG. 5 illustrates an exemplary embodiment of the caregiver portable computing device 60. The caregiver portable computing device 60 may include a memory 62, a processing unit 64, a battery 66, user interface tools 68, network interface 70, RF communication tools 59, and identifier recognition tools 72. The user interface tools 68 may advantageously be accessible through a built-in display device 74. The identifier recognition tools 72 may be connected with a scanning device 78 such as an embedded barcode scanner.

In an embodiment of the invention the caregiver portable computing device 60 is a handheld personal digital assistant (PDA). The PDA puts the power of the central database 50 in the caregiver's hands at the point of care. The PDA recognizes identifiers associated with the patient 2, caregiver 10, devices 6, or procedures. The PDA prompts the caregiver 10 for necessary actions and information during the care-giving process.

The caregiver portable computing device 60 is used as verification device and in an embodiment of the invention is a barcode scanner for the patient identification device and the caregiver identification device. Caregivers may be provided with varying access levels. For instance, a physician may be able to enter tasks, but some less skilled caregivers may not be permitted such a high access level. In this instance, the caregiver portable computing device 60 is capable of verifying access level through the central database 50 and the caregiver identification device 12.

The caregiver portable computing device 60 accesses the central information system 20 through the network interface 70 and prompts caregivers for scheduled tasks, alerts them to potential error, facilitates documentation, and allows caregivers to review data before posting it to central database. Real time updates and current access orders are available through the caregiver portable computing device 60 in real time.

FIG. 6 illustrates an embodiment of the patient identification device 4 including an identifier 5. The identifier 5 is preferably in machine-readable form and may be a scannable barcode or RFID. The patient identification device 4 may be in the form of a patient wristband. The caregiver identification device 12 preferably also includes the identifier 5. The caregiver identification device 12 may be affixed to a caregiver badge in an embodiment of the invention. The medical device and medication identification device 8 preferably also includes a machine-readable identifier as shown. The identifiers associated with the patient, caregiver, and device are preferably all linked to specific data within the central information system database 50.

Every apparatus and medication used in medical treatment of a patient may be labeled with an identifier such as a barcode. Anything that can be tagged with an identifier can be monitored by the system of the invention. For instance, an IV bag coming from the pharmacy including medications can be labeled at the pharmacy with an identifier such as a barcode. In practice, the caregiver would scan the labeled medication before adding it to a pump. The labeled medication may be compared with the patient identifier 5 and tasks on record such as patient dose, timing, and pump setting. Since the pump can also be labeled with an identifier, the system, through the caregiver portable computing device 60 looks for an IV pump to associate with the identified IV bag. The physical infrastructure provides a mechanism for scanning a barcode that is unique to the IV pump. The tubing attached to the pump and IV bag may also receive an identifier. The system then compares dose, timing, and pump setting with orders on record. In this instance, the caregiver portable computing device 60 could provide a green light if all information matches or an alert if a mismatch occurs. In additional to pumps, any of a number of other medical devices that are attached, inserted, laid upon or otherwise physically associated with a patient may be receive an identifier. These devices include a peripheral IV, a central line, a PA catheter, an arterial line, temporary pacemaker wires, epidural catheters, subdural catheters, endotracheal tubes, chest tubes, surgical drains and urinary catheters and implantable devices such as VP shunts, tracheostomies, cardiac pacemakers, medication pumps, implanted central lines, dialysis shunts and vascular filters. Thus, the attachment type may be identified by the physical connection or the medical device associated with connection. Likewise, the products associated with these devices may also be identified, and may be used similarly to the pump-IV medication combinations described herein.

The contents of manually administered medications may also be labeled with a bar code, RFID, or other machine readable identifier. Labeling reduces the possibility of a patient receiving incorrect medication or receiving medication at inappropriate intervals or in inappropriate dosages. Collected specimens may also be labeled with identifiers. With the addition of a mobile printer (not shown), specimens can be labeled at the moment of collection, thus further reducing opportunities for error.

Labeling each component with an identifier provides a physical structure to make IV pumps and other medical devices part of the care environment and part of the workflow. If more than one medication, IV bag, or pump is present, the system is capable of distinguishing them from one another because of the aforementioned identifiers.

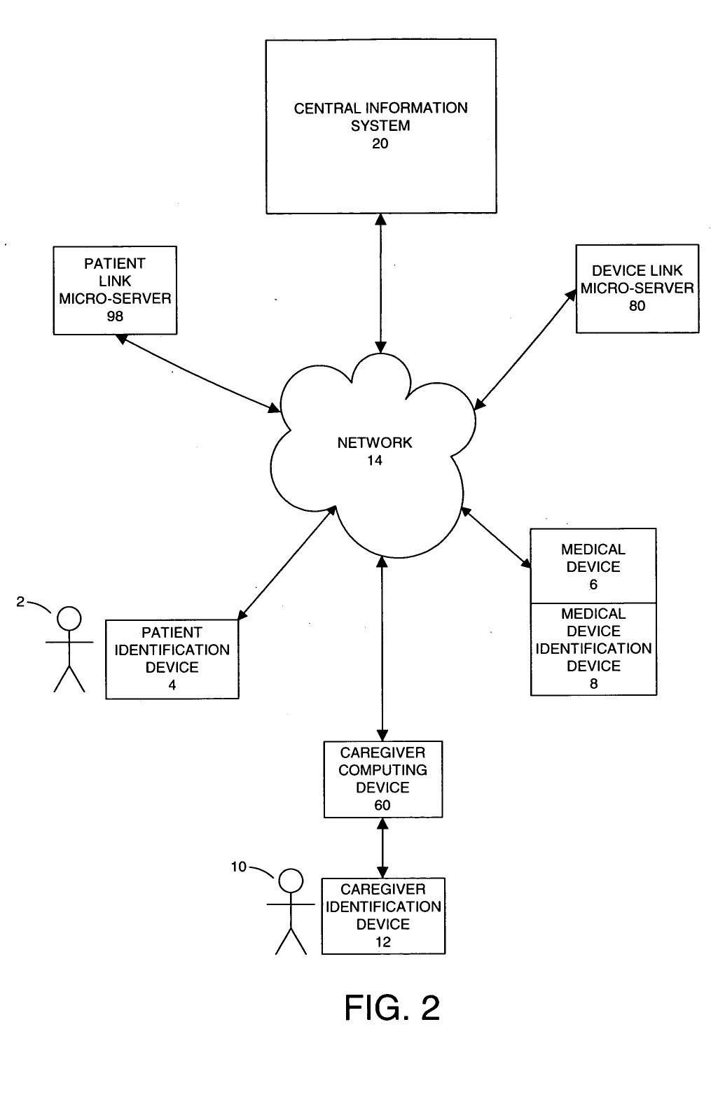

In a second embodiment of the system of the invention as shown in FIG. 2, additional components may be included such as a device link micro-server 80 and a patient link micro-server 98. In implementing the system of the invention, these micro-server components 98 and 80 may both be included or either component 98 or 80 may selectively be implemented.

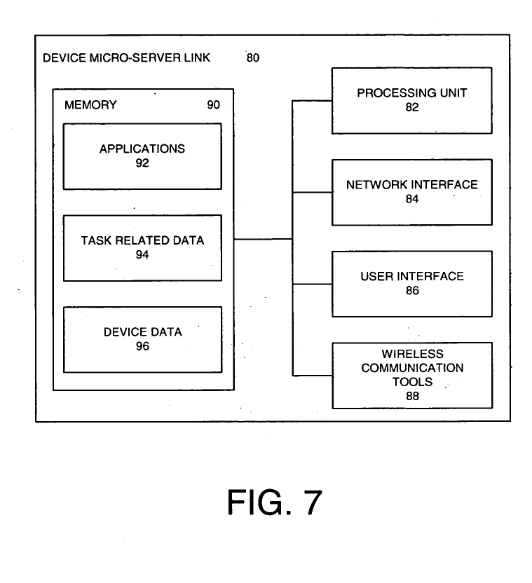

FIG. 7 illustrates an embodiment of the device link micro-server 80. The device link micro-server 80 may include a processing unit 82, a network interface 84, a user interface 86, and wireless or wired communication tools 88. The device link micro-server 80 may also include a memory 90 including applications 92, task related data 94, and device data 96. The device link micro-server 80 has a device driver within its applications 92 and is capable of determining an appropriate communication protocol for the attached device. The device link micro-server 80 uses standard language protocols to communicate with any device and then converts that information to an appropriate format for user by central information system 20. Although all components are shown as communicating over the network 14, peer-to-peer communication may also be possible.

The patient link micro-server 98 may be substantially identical in structure to the device link micro-server 80 and performs a similar function. However, the application programs running on the two devices may differ. The patient link micro-server 98 and t h e device link micro-server 80 provide caching or local storage of data. The infrastructure of the micro-server devices 80 and 98 allows retention of data and management at nursing unit level. Although the system can function without the micro-servers 80 and 98 as exemplified by FIG. 1, it is desirable to provide an offline data store. Data in the micro-servers 80 and 98 may be stored as tagged extensible mark-up language (XML) data.

Both the patient link micro-server 98 and the device link micro-server 80 are capable of functioning as web servers. The patient link micro-server 98 may function as a web server that caches patient authentication and demographic information for a single associated patient, task data generated from physician orders, and limited clinical result information. Through the wireless or wired communication tools 88, the patient link micro-server 98 communicates with the caregiver portable computing device 60 and the central information system 20 as shown in FIG. 2. The patient link micro-server 98 preferably communicates with the central database 50 via XML but may also support HL7 and could be configured to operate using the Cerner Millennium™ architecture of Cerner Corporation of Kansas City, Mo., or in any appropriate manner in the context of the provided central information system 20.

Each patient may be provided with the patient link micro-server 98. The micro-server 98 may be wireless or hardwired or both to both the central information system 20 and/or the caregiver portable computing device 60, but may record and transmit information about one particular patient. The patient link micro-server 98 stores a snapshot of all information about the associated patient, thus providing back up in case information in the central database 50 becomes inaccessible. The patient link micro-server 98 is capable of functioning as a link between the central database 50 and everything that happens to the patient 2.

Accordingly, the patient link micro-server 98 provides a local, real time, and redundant secondary data store that are specific to the patient. The patient link micro-server 98 is preferably located in the patient room and is connected to the central information system 20 through either a wireless are hardwired connection. The patient link micro-server 98 receives continuous updates to patient-specific information including patient demographics, results, and planned care activities. The data store is temporary, functions during a single episode of care, and may be automatically flushed of data upon discharge of the patient. Thus, the patient link micro-server 98 and the device link micro-server 80 function as localized web servers with information that the caregiver 10 can query.

The caregiver portable computing device 60 with the embedded barcode scanner or other identifier recognition mechanism is preferably capable of communication with the device link micro-server 80 and the patient link micro-server 98 with an RF signal. As discussed above, the patient link micro-server 98 is located in the patient environment and preferably holds the local data store that may be wired to a local network but may also communicate to other components via RF signal. The device link micro-server 80 is attached directly to any patient-attached devices and may communicate to other components via RF signal. Both devices can communicate over the network 14 with the central information system 20 that supplies primary patient-specific information to the patient link micro-server device 98 while the central information system 20 is available.

Both the patient link micro-server 98 and the device link micro-server 80 may continually cache patient specific data from the caregiver portable computing device 60 and any connected medical devices. The cache of information from the micro-servers 80 and 98 may be available from any authorized web browser. The micro-servers 80 and 98 may be directly accessible via a browser over a wired network or using a direct RF network link to the patient link micro-server embedded RF node or the device link micro-server RF node. For access outside the institutional firewall, the micro-servers 80 and 98 may support appropriate encryption schemes. Accordingly, the system continues to support and record care activities even during database downtime because access to the data cached in the micro-servers 80 and 98 is available via a web browser independent of the primary information system is still available.

The micro-servers 80 and 98 are capable of functioning continuously during downtime of the central information system 20 and have the ability to automatically re-synchronize with the central information system 20 when it becomes available. The patient link micro-server 98 receives updates from the central information system 20 based on design criteria and sends updates to the central information system 20 regarding patient activity and acquired device data. Further, the patient link micro-server 98 stores a record of activity performed at the bedside and any data provided to it by adjacent device link micro-servers 80. In the absence of the central information system 20, the patient link micro-server 98 will continue to check activities against its most current activity list and will queue activity updates and data until the central information system 20 signals its availability to accept those updates.

Additionally, as briefly mentioned above, the patient link micro-server 98 may be designed to communicate directly with multiple, bedside patient-attached devices through the device link micro-server 80. In embodiments of the invention, the patient link micro-server 98 is capable of communicating with up to eight device link micro-servers 80.

Data streaming from patient-attached devices is stored continuously in the patient link micro-servers 98 for access by the caregiver 10. The device link micro-server 80 inherits and supports the full range of commands and functions provided by the device manufacturer for each device attached and operates in conjunction with the patient link micro-server 98 to manage the device 6.

The caregiver portable computing device 60 can be used to configure the patient link micro-server 98. In use, the caregiver portable computing device 60 scans the patient identifier 5, an identifier associated with the patient link micro-server 98, and an identifier associated with the device link micro-server 80. This action initiates a routine in the patient link micro-server 98 that initiates a request to the central information system 20 for all patient-specific demographics, results, and activity data for temporary storage in the application server. Devices attached to the device link micro-server 80 become associated to the patient by virtue of their association with the patient-specific patient link micro-server 98.

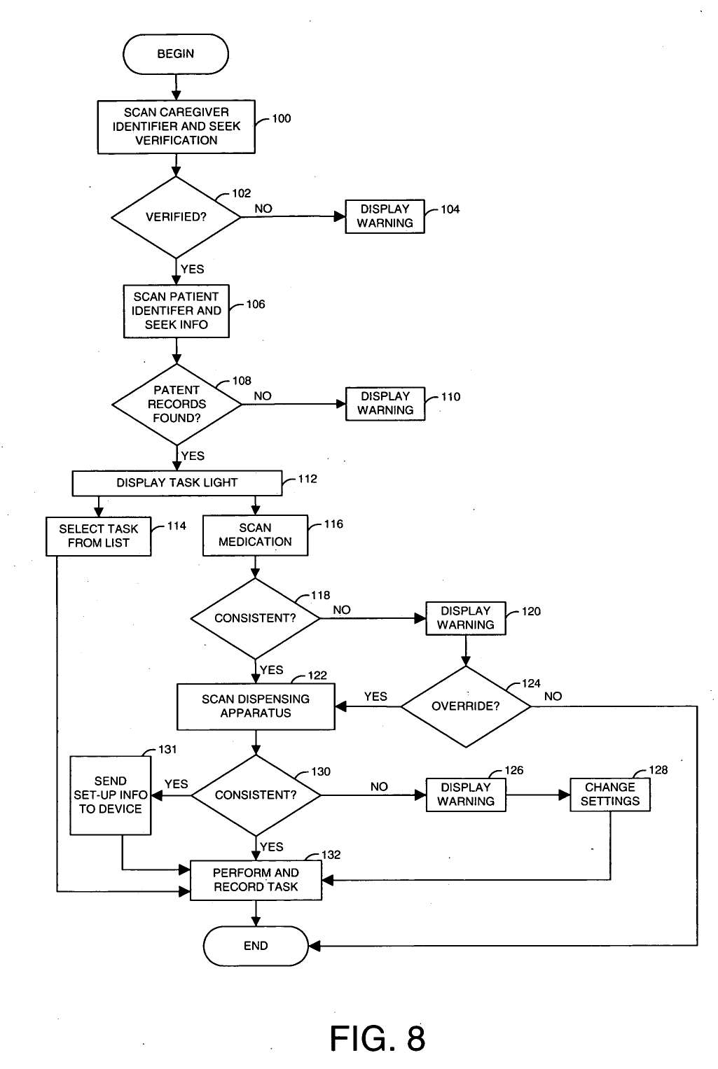

FIG. 8 illustrates an embodiment of a method for using the system described above with reference to FIGS. 1-7. The description of FIG. 8 differs depending upon whether the embodiment of FIG. 1 or FIG. 2 is implemented. FIG. 8 is described below in relation to each of the two systems separately.

Using the system of FIG. 1, in step 100, the caregiver 10 performs self-authentication by scanning the caregiver identification device 12 with the caregiver portable computing device 60. Preferably, the caregiver scans the identifier on her security badge. This may be accomplished using an embedded bar code reader or other identifier recognition device on the caregiver portable computing device.

In step 102, the caregiver portable computing device attempts to receive verification of the caregiver's identity from the central information system 20. If the identity is not verified, a warning may be displayed in step 104.

If the caregiver identity is verified, the caregiver may scan the patient identifier in step 106. Preferably, the caregiver swipes an identifier on the patient's wristband to identify the patient. The system knows which tasks are due and prompts the caregiver to enter data or confirmation for each one.

In step 108, if no matching patient records are found in the central information system 20, a warning may be displayed on the caregiver portable computing device in step 110. If the matching patient records are found in step 108, the caregiver portable computing device retrieves the task list from the central information system 20 and displays it in step 112. Upon receiving the task list in step 112, the caregiver may either select a task from the list in step 114 or scan a medication in step 116.

If the caregiver selects a task from list in step 114, the caregiver may perform and record the task in step 132. If the caregiver chooses to scan a medication in step 116, the central information system determines in step 118 whether the scanned medication is consistent with the displayed task list. If the medication is not consistent, the caregiver portable computing device may display a warning in step 120. In step 124, in some instances, the caregiver may be given the option to override the mismatch and administer the medication.

If the medication is consistent with the task list in step 118 or if the caregiver chooses to override the inconsistency in step 124, the caregiver may scan the dispensing apparatus in step 122. An exemplary dispensing apparatus would be an IV pump.

If the settings on the dispensing apparatus are consistent with the task list in step 130, the caregiver may perform and record the task in step 132. As an alternative path, set-up information may be sent to the device in step 131 before performing and recording the task in step 132. Otherwise, if the settings on the dispensing device are inconsistent with the task list in step 130, the caregiver portable computing device may display a warning in step 126. In step 128, the caregiver may change settings and perform and record the task in step 132. With one click (or other input), the caregiver can send information to the patient record in the central database. If there is a discrepancy, the caregiver portable computing device alerts the caregiver by flashing a color code to eliminate the possibility that the problem will be overlooked. When a task is completed, the central information system records completion of the task.

Using the embodiment of FIG. 2, in step 100, the caregiver 10 performs self-authentication by scanning the caregiver identification device 12 with the caregiver portable computing device 60. Preferably, the caregiver scans the barcode or other machine readable identifier on her security badge using an embedded bar code reader or other identifier recognition device on the caregiver portable computing device. In step 102, the caregiver portable computing device attempts to receive verification of the caregiver's identity from the patient link micro-server. If the identity is not verified, a warning may be displayed in step 104.

If the caregiver identity is verified, the caregiver may scan the patient identifier in step 106. The patient link micro-server immediately accesses the patient's records to provide assigned tasks during this window of time. The system knows which tasks are due and prompts the caregiver to enter data or confirmation for each one.

In step 108, if no matching patient records are found in the patient link micro-server, a warning may be displayed on the caregiver portable computing device in step 110. If the matching patient records are found in step 108, the caregiver portable computing device retrieves the task list from the patient link micro-server and displays it in step 112. Upon receiving the task list in step 112, the caregiver-may either select a task from the list in step 114 or scan a medication in step 116.

If the caregiver selects a task from list in step 114, the caregiver may perform and record the task in step 132. As an alternative path, set-up information may be sent to the device in step 131 before performing and recording the task in step 132. If the caregiver chooses to scan a medication in step 116, the patient link micro-server determines in step 118 whether the scanned medication is consistent with the displayed task list. If the medication is not consistent, the caregiver portable computing device may display a warning in step 120. In step 124, in some instances, the caregiver may be given the option to override the mismatch and administer the medication.

If the medication is consistent with the task list in step 118 or if the caregiver chooses to override the inconsistency in step 124, the caregiver may scan the dispensing apparatus in step 122.

If the settings on the dispensing apparatus are consistent with the task list in step 130, the caregiver may perform and record the task in step 132. Otherwise, if the settings on the dispensing device are inconsistent with the task list in step 130, the caregiver portable computing device may display a warning in step 126. In step 128, the caregiver may change settings and perform and record the task in step 132. With one click, the caregiver can send information to the patient record to the patient link micro-server 98. If there is a discrepancy, the caregiver portable computing device alerts the caregiver by flashing a color code to eliminate the possibility that the problem will be overlooked. When a task is completed, the patient link micro-server 98 records completion of the task. When the central information system 20 is available, the patient link micro-server 98 forwards the data pertaining to completed tasks.

As set forth above, FIG. 8 includes multiple consistency checks to enhance the safety of the system and method of the invention. Consistency checks ensure that the patient, medication, dose, timing, and route are accurately identified.

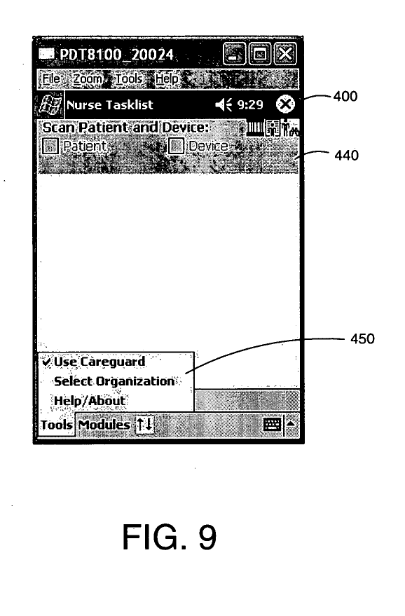

FIGS. 9-16 illustrate the screen displays that appear on the caregiver portable computing device 60 during the method of FIG. 8.

FIG. 9 illustrates a screen display shown on the caregiver portable computing device after the caregiver has logged in. The caregiver is logged in and a nurse task list 400 appears upon nurse identification. The options of scanning the patient and device are shown in the region 440. A selection menu 450 is also shown. Although the caregiver may select from the menu, the caregiver may also simply scan the patient, thereby avoiding any manual caregiver input.

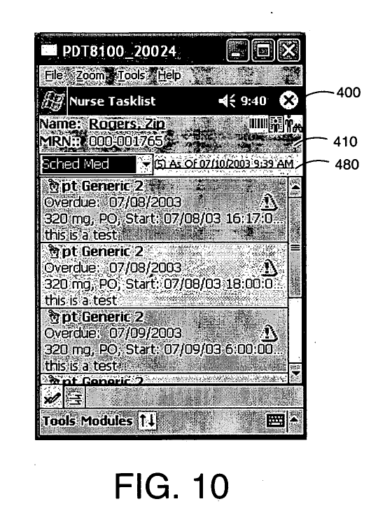

FIG. 10 illustrates a screen display showing a filter list of scheduled medications 480 and the patient name and identification number 410. A caregiver can either select from the list 480 or scan any of the medications shown. Scanning the medication again avoids manual caregiver input and therefore further reduces chances for error.

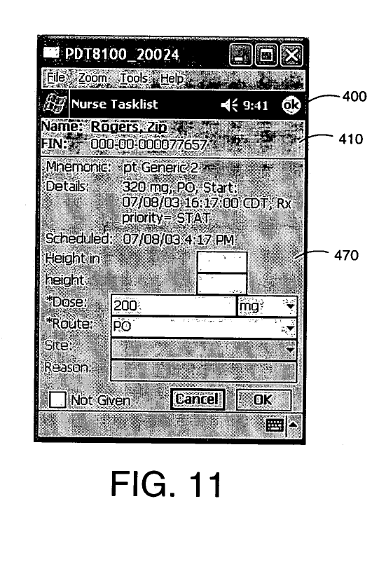

FIG. 11 illustrates a screen display that appears upon scanning of the medication. The medication dosage information data and patient data are shown in region 470.

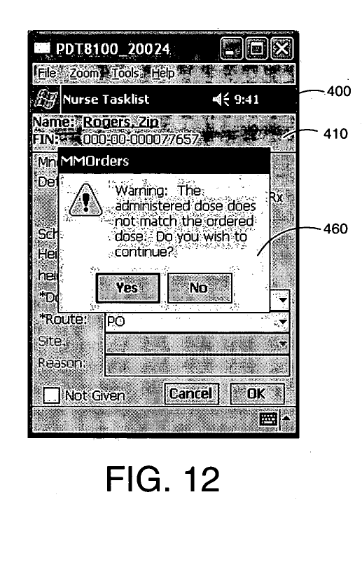

FIG. 12 illustrates a screen display of the caregiver portable computing device that might appear if the scanned medication or dosage does not match the task list. A warning 460 appears indicating that the dose to be administered does not match the ordered dosage. In the displayed embodiment, the caregiver is given the opportunity to continue regardless of the mismatch. This opportunity may not be offered in all embodiments of the invention.

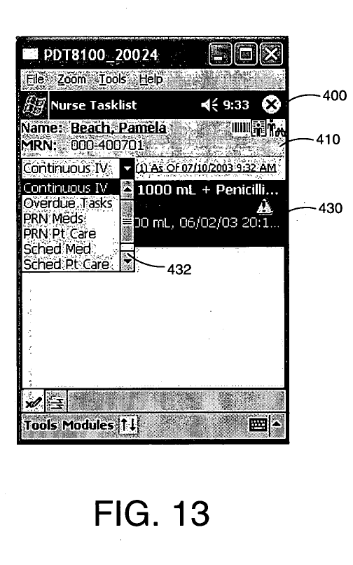

FIG. 13 shows the screen display with the options available in the drop down task list 432. With “continuous IV” selected, the information 430 shows on the screen related to available IVs.

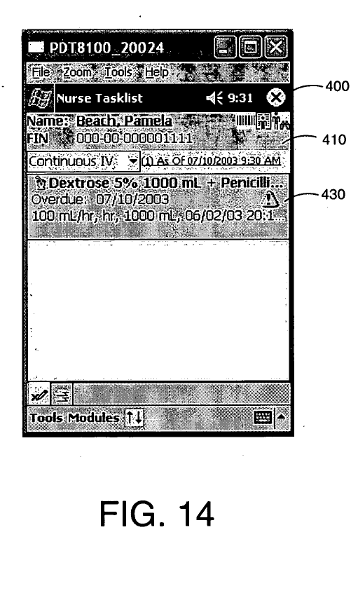

FIG. 14 illustrates a screen display of the caregiver portable computing device showing the status if the caregiver selects “continuous IVs” from the list 410. The list is then filtered to display only IVs 430.

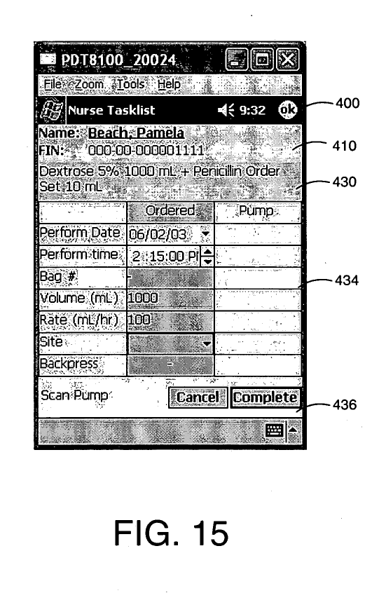

FIG. 15 shows the screen display if the caregiver scans an IV bag, but the pump has not yet been scanned. The IV information 430 is shown. In order to complete the display, the caregiver-may scan the pump to locate the pump settings. The scanning of the pump helps avoid the possibility of caregiver error. Pump data 434 becomes available when the caregiver scans the pump. Cancellation and completion options 436 are selectable by the caregiver.

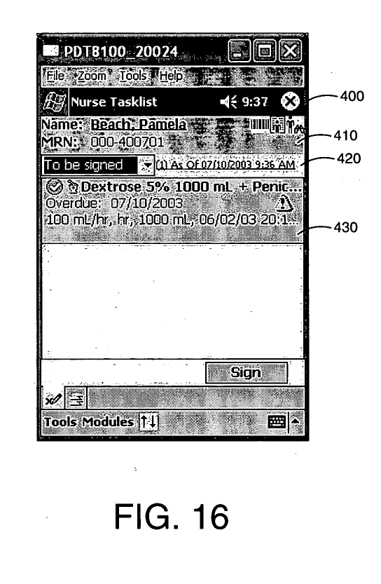

FIG. 16 illustrates a screen display requiring the caregiver's signature 420 after an order for a medication 430 has been performed.

As exemplified by FIGS. 8-16, the system is capable of verifying care events against tasks stored in the local data store or the central information system as the tasks are performed. Future actions with the patient are validated using barcode identifiers against the list of known ordered activities (tasks). Actions that are not expected or not represented on the list of known activities are flagged on the caregiver portable computing device for review by the caregiver at the time the task is being performed. Future actions with the patient are validated using barcode identifiers against the list of known ordered activities. The local data store or the central information system associates actions to their corresponding tasks and notes an exception when no associated task is found.

Additionally, the system anticipates the actions of the caregiver based on planned activities and presents information largely for confirmation. The central information system or patient link micro-server infers the caregiver's intended workflow from the order barcodes or identifiers entered into the system combined with information on care activities that are expected at the current time. The caregiver may alternately choose a workflow from a menu on the caregiver portable computing device. Once the workflow is established, the caregiver portable computing device provides feedback to the caregiver on the status of actions as they are performed via the barcodes or identifiers and obtains confirmation from the caregiver before proceeding at key points in the workflow. The workflow and confirmation points may be configured by the institution in a manner consistent with institutional internal procedures.

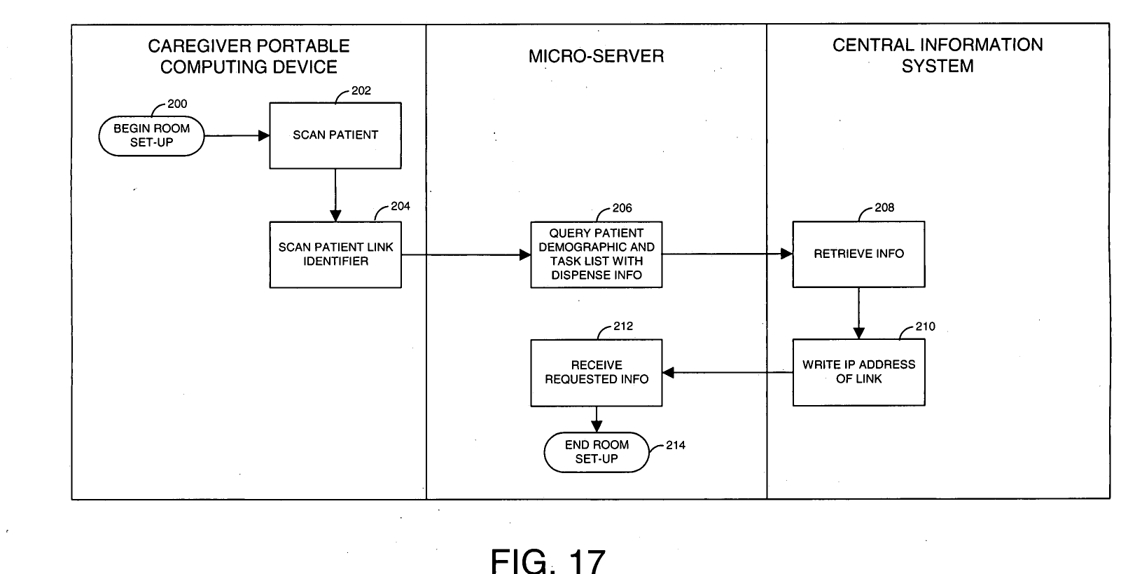

FIG. 17 illustrates a caregiver's interaction with the second embodiment of the system of the invention to set up a patient room. This procedure is implemented only when a patient is first transferred to a room. Using the caregiver portable computing device 60, in step 200, the caregiver begins room set-up. In step 202, the caregiver scans the patient, and in step 204, the caregiver scans the patient link micro-server. In step 206, the patient link micro-server queries the patient demographic and task list that includes dispensing information. In step 208, the information is retrieved from the central information system 20. In step 210, the central information system 20 writes an IP address of the patient link micro-server. In step 212, the patient link micro-server 98 receives the requested information and in step 214, room set-up is ended.

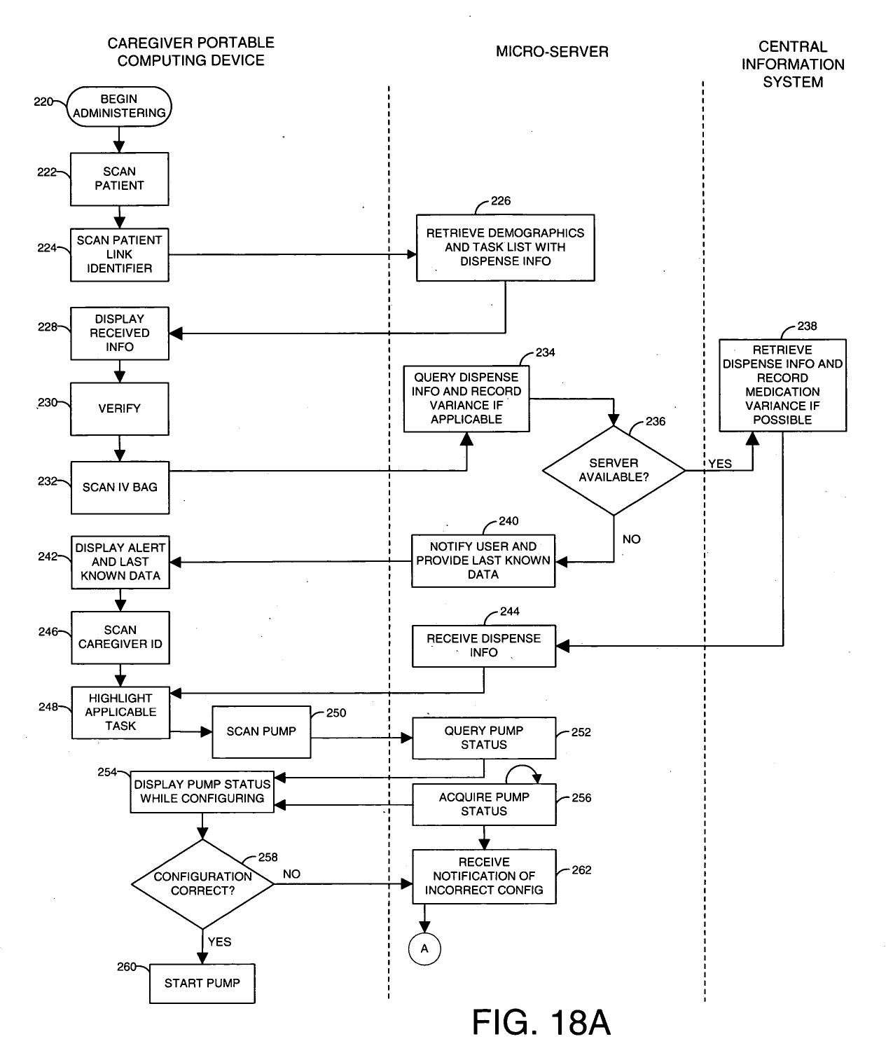

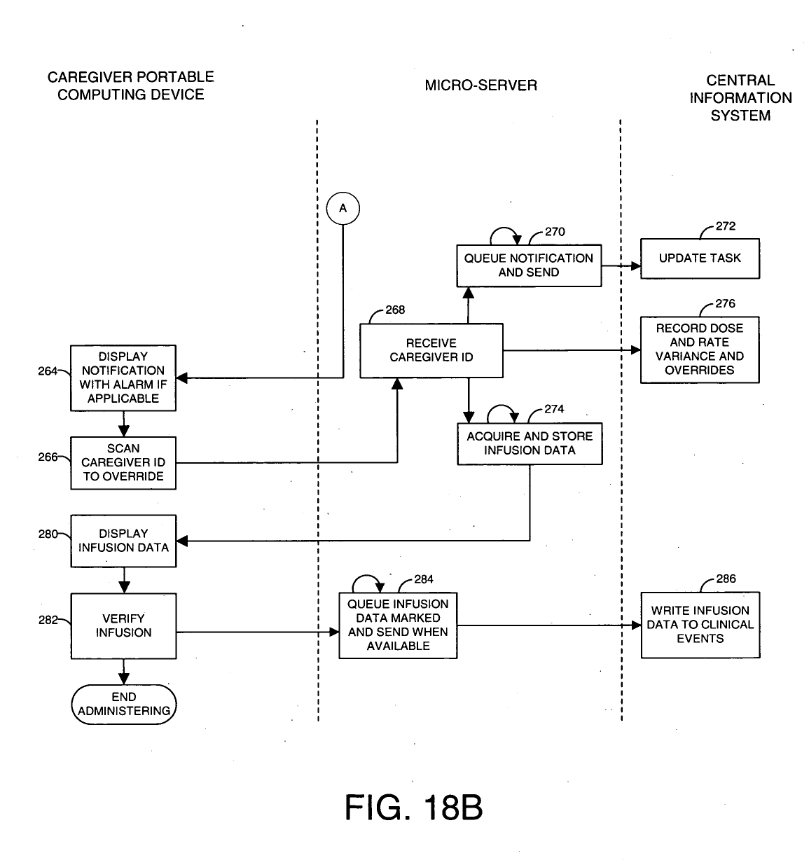

FIGS. 18A and 18B illustrate further details of a method for using the system of the invention in a single-patient multiple-device environment. After the room set-up of FIG. 17, the caregiver may begin administering medication in step 220. In step 222, the caregiver scans the patient. In step 224, the caregiver scans the patient link micro-server. In step 226, the patient link micro-server retrieves demographics and a task list with dispensing information. In step 228, the caregiver portable computing device displays received information and verifies the information in step 230. In step 232, the caregiver portable computing device scans an IV Bag. The caregiver portable computing device sends the information to the patient link micro-server to query dispensing information and record variance if applicable in step 234. In step 236, the patient link micro-server determines if the central information system is available.

If the central information system is not available in step 236, the patient link micro-server will provide the last known data to the caregiver portable computing device in step 240. In step 242, the caregiver portable computing device displays an alert and last known data. In step 246, the caregiver scans an identifier to acknowledge that the current data is displayed.

If the central information system is available, the patient link micro-server retrieves dispensing information and records medication variance if available in step 238. In step 244, the patient link micro-server receives dispensing information.

After either of steps 244 or 246, the applicable task is highlighted on the caregiver portable computing device. In step 250, the caregiver scans the pump and in step 252, the patient link micro-server queries pump status. In step 254, the caregiver portable computing device displays the pump status. If the pump status configuration is not correct in step 256, the caregiver portable computing device sends notification to the patient link micro-server in step 262. If the configuration is correct, the pump starts in step 260.

In FIG. 18B, if the configuration was incorrect, the caregiver portable computing device displays notification with an alarm if applicable in step 264. In step 266, the caregiver can scan the caregiver identifier to override. In step 268, the patient link micro-server receives the caregiver ID. In step 270, the patient link micro-server queues and sends notification to the central information system. The central information system updates the task in step 272. Also, in step 268, the patient link micro-server receives the caregiver identifier and the central information system records dose and rate variance and overrides in step 276.

In step 274, the patient link micro-server acquires and stores infusion data. In step 280, the caregiver portable computing device displays infusion data and verifies infusion in step 282. In step 284, the patient link micro-server periodically queues infusion data marked and sends the data when available. In step 286, the central information system writes infusion data to a clinical events file.

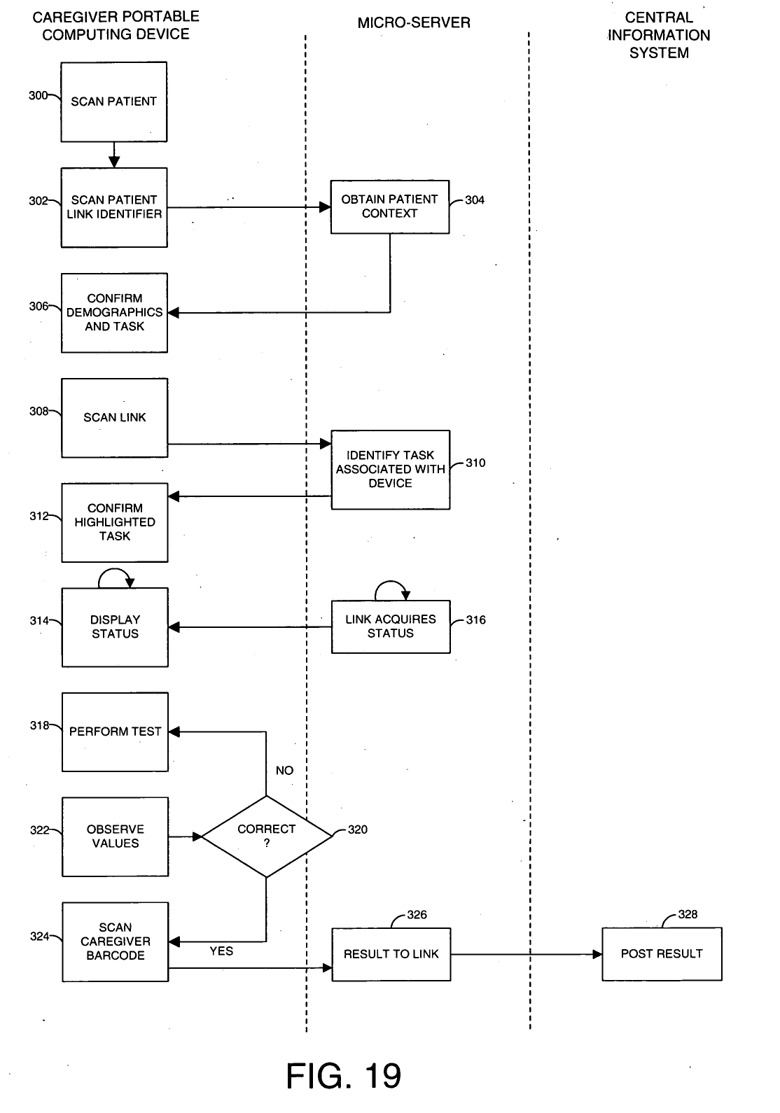

FIG. 19 shows various methods for using the system of the invention in a multi-patient single-device environment. In step 300, the caregiver portable computing device scans the patient. The caregiver portable computing device scans the patient link micro-server in step 302. In step 304, the patient link micro-server obtains the patient context. In step 306, the caregiver portable computing device confirms patient demographics and task.

In step 308, the caregiver portable computing device scans the patient link micro-server. In step 310, the patient link micro-server identifies the task associated with the device. In step 312, the caregiver portable computing device confirms the highlighted task.

On an ongoing basis, whenever the patient link micro-server acquires status in step 316, the caregiver portable computing device displays status in step 314.

In step 318, the caregiver performs a test and observes values in step 322. If the values are correct in step 320, the caregiver scans the caregiver barcode or other machine-readable identifier in step 324, sends the result to the patient link micro-server in step 326 and posts the results to the central information system in step 238.

Using the above-described system and method, all tasks performed with respect to a patient are recorded on the caregiver portable computing device and transmitted to the central information system 20 either through the patient-link server 98 or directly. Caregivers have no opportunity to record data inaccurately as with currently existing systems.

The presently disclosed system is person-centric as it is designed to move with patient. The instant identification and access provided by the disclosed system is very important for situations in which documentation is not readily available, such as emergency care. Using network capabilities, a single caregiver can monitor multiple parameters for dozens of patients. The presently disclosed system can be used to help monitor resources and allows less skilled personnel to handle routine tasks. The invention is not limited to use in any particular setting. It can be used in any setting in which multiple patients or caregivers are present.

Additionally, the system provides an extra measure of protection with its built in data redundancy and downtime access. If the central information system is down due to scheduled maintenance, unscheduled electrical failure, or other event, the local devices such as the device link micro-server 80 and the patient link micro-server 98 save all data since the last connection to central information system 20.

The disclosed system is safer more efficient that currently used systems because it eliminates unnecessary steps. With the disclosed system, a caregiver can receive directions at a patient's bedside by scanning barcodes or recognizing other machine-readable identifiers. The scanning creates the documentation and eliminates the need for an additional process. Furthermore, since the system uses a central database, last minute change in orders can be captured. A physician can make adjustments and be certain that caregiver will be alerted in real time. Test results can also be made available as needed and appropriate. The availability of changes to the central information system in real time helps to eliminate errors that occur due to any existing time lag.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set for above, together with other advantages, which are obvious and inherent to the system and method. It will be understood that certain features and sub-combinations are of utility and may be employed without reference to other features and sub-combinations. This is contemplated and within the scope of the appended claims.

1. A system for managing patient care, the system comprising:
a portable information device having a identifier recognition mechanism;
a patient machine readable identifier; and
a patient task list for an identified patient, wherein the task list becomes automatically available upon recognition of the patient machine readable identifier by the scanning device.

2. The system of claim 1, further comprising a caregiver machine readable identifier attached to a caregiver badge.

3. The system of claim 1, further comprising a central information system including patient data, wherein the portable information device includes wireless communication tools for verifying patient data with the central information system.

4. The system of claim 1, further comprising a central information system including caregiver data, wherein the portable information device includes wireless communication tools for verifying caregiver data with the central information system.

5. The system of claim 1, wherein the patient task list comprises instructions for administration of at least one medication.

6. A method for managing patient care comprising:
recognizing a patient machine-readable identifier;
matching the patient machine-readable identifier with a patient task list; and
providing the task list to a caregiver.

7. The method of claim 6, further comprising providing a task list including at least one medication administration task.

8. The method of claim 7, further comprising recognizing a medication machine-readable identifier and matching the machine-readable with a medication from the task list.

9. The method of claim 8, further comprising recording administration of the medication.

10. The method of claim 6, further comprising recognizing a caregiver identifier.

11. The method of claim 6, further comprising implementing a portable information device with an embedded scanner for scanning the patient machine readable identifier.

12. The method of claim 11, further comprising transmitting the patient identifier from the portable information device to a central information system.

13. The method of claim 12, further comprising verifying patient identity through information available in the central information system.

14. The method of claim 13, further comprising receiving current patient related tasks from the central information system at the portable information device.

15. The method of claim 13, further comprising using the portable information device to obtain a caregiver identifier, transmitting the caregiver identifier from the portable information device to the central information system, and receiving verification of the caregiver identity from the central information system at the portable information device.

16. The method of claim 15, wherein obtaining the caregiver identifier comprises scanning a machine-readable identifier using an embedded reader in the portable information device.

17. A task-based system for managing patient care, the system comprising:
a central information system having a database including patient data;
a patient identifier for identifying a patient; and
a portable information device having tools for reading the patient identifier and accessing the central information device to obtain the patient data, wherein the central information system includes an application for dynamically generating a task list upon obtaining the patient data.

18. The system of claim 17, further comprising a caregiver machine-readable identifier attached to a caregiver badge.

19. The system of claim 17, wherein the portable information device includes wireless communication tools for verifying patient data with the central information system.

20. A method for facilitating task performance by a caregiver, the method comprising:
verifying a caregiver identifier and a patient identifier using a portable information device;
generating a task list for the identified caregiver and the identified patient; and
individually recording performance of each task.

21. The method of claim 20, further comprising using a portable information device with a scanner to scan the caregiver identifier and the patient identifier.

22. The method of claim 20, further comprising transmitting the caregiver identifier and the patient identifier from the portable information device to a central information system.

23. The method of claim 22, further comprising verifying patient identity through information available in the central information system.

24. The method of claim 20, further comprising dynamically generating the task list at the central information system and sending the task list to the portable information device.

25. The method of claim 20, further comprising obtaining a medication identifier from an identification device including a bar code identifying a particular medication.
